(19) United States
(12) Patent Application Publication
(10) Pub. No.: US 2007/0223685 A1
(43) Pub. Date: Sep. 27, 2007

(54) Secure system and method of providing same

(76) Inventors: David Boubion, Tampa, FL (US); Peter Rung, Lutz, FL (US); Mary Claire Ryan, Burr Ridge, IL (US)

Correspondence Address: MCDERMOTT, WILL & EMERY LLP, 227 WEST MONROE STREET, SUITE 4400, CHICAGO, IL, 60606-5096, US

(21) Appl. No.: 11/703,463

(22) Filed: Feb. 6, 2007

Related U.S. Application Data
(60) Provisional application No. 60/771,204, filed on Feb. 6, 2006.
(60) Provisional application No. 60/778,727, filed on Mar. 3, 2006.

(51) Int. Cl. H04K 1/00

(52) U.S. Cl. 380/2

(57) ABSTRACT

A secure system, and method of providing a secure system, including a user authentication device and a secured device. The user authentication device includes memory, one or more authentication factors, access key information, a microCPU, an authentication factor input and a communication port. The secured device includes a microCPU and a communication port that receives access key information from the authentication device. An authorized user may be granted access to the secured device after the user is authenticated by the user authentication device and the user authentication device is authenticated by the secured device.

### TECHNICAL FIELD

The present subject matter relates generally to a data security, storage and communication system for preventing unauthorized access to physical or electronic assets. More specifically, the present invention relates to a secure system, and method of providing same, using a user authentication device that utilizes protected authentication factors to authenticate a user and a secured device that authenticates the user authentication device before granting access to or communications with the secured device.

### BACKGROUND

A computer is typically operated by first starting its operating system, which then begins the process of communicating with the basic input/output system (BIOS) in the computer. In order to execute any command electronically, a command or program execution is processed through an intelligent micro processing unit (microCPU). As used herein, the term microCPU refers to any electronic device having an operating system and/or a central processing unit. Communication with the BIOS enables activation of all functions on the mother board. Although there are security products available to secure a personal computer (PC), the inherent fault in existing security is that the security systems run within the PC's logical infrastructure, which by default communicates with the operating system and the BIOS. As a result, there are “history traces” left behind on the system, in the cache, the firmware, the memory, etc., which can be accessed through the operating system and BIOS. An intruder with access to the history traces may access usernames and passwords, enabling even greater access to secured information stored in the PC. This is the tactic used by hackers and phishers to obtain private and confidential user information.

Most physical access control technologies involve some sort of authentication device that must interact physically or be placed in close proximity to a controller. For example, a password, pass code, magnetic card, RFID card or other smart card may be used in association with a wall mounted lock. The mounted device stores the identification values to be matched by the authentication device. Accordingly, the system can be compromised either by accessing the identification values stored in the wall mounted device or by acquiring an authentication device, whether lost or stolen. If there is a registry for the keys to be used with the mounted device, there must also be a central repository for those keys, which may be susceptible to security breach. If the registry is stored on a server, there is also a possibility the security to the server may be breached.

Therefore, a need exists for a system and method in which the integrity of both the object (e.g., the data) and subject (e.g., the user) is preserved in the process of authentication and verification.

### SUMMARY

As used herein, authentication is the act of establishing or confirming someone's or something's identity. For example, authentication of an object may be defined as confirming its state of existence. Authenticating an object may further include verifying that its source or origin is trustworthy. Authentication of a person may be defined as verifying that person's identity.

As used herein, an authentication routine is a process of authentication that may depend upon one or more authentication factors. As a non-limiting example, an authentication routine may include confirming something or someone's characteristics and/or data match a tabulated and/or stored value.

As used herein, an authentication factor is a piece of information used to verify identity or status for security purposes, and may be represented in any of the following forms: (1) who the user is—e.g., biometrics; (2) what a user has—e.g. a token or key; (3) what a user knows—e.g., social security number, a password, birth location; (4) where the user is—e.g., a GPS location; and (5) when the user is—e.g., time on the Greenwich Mean Time clock. Biometrics is an example of an authentication factor directed to determine who is being authenticated. Authentication factors can be used to authenticate who, what, where and when.

As used herein, symmetric authentication refers to a one-way authentication routine; typically from a person to an authenticating device or from an authenticating device to a secured device.

As used herein, asymmetric authentication refers to a two-way authentication routine; typically between an authenticating device and a secured device.

As used herein, biometrics refers to physical characteristics that produce a value that is exclusive to an individual's identity, such as, for example, fingerprints, vocal patterns, eye retinas and irises, facial patterns, hand measurements, vein patterns, DNA, etc.

As used herein, multi-factor authentication is the use a plurality of authentication factors within an authentication routine. For example, any number of the following classes of authentication factors may be used in part or in totality in an authentication routine. For example, a multi-factor authentication routine for a person may include determining more than one of the following: (1) who the user is—e.g., biometrics; (2) what a user has—e.g. a token or key; (3) what a user knows—e.g., social security number, a password, birth location; (4) where the user is—e.g., a GPS location; and (5) when the user is—e.g., time on the Greenwich Mean Time clock. The more authentication factors utilized, the higher confidence and security of authentication is achieved. Therefore, a higher level of security may be achieved by using multi-factor authentication.

Encryption is the process of obscuring information to make it unreadable without special knowledge of the seed. The term random seed, seed or seed state is a number (or vector) used to initialize a pseudorandom number generator. Encryption is used to protect data information and communication pathways to achieve high levels of privacy and secrecy. Strong encryption has emerged from government agencies into the public domain as part of international standards activities. It is used in protecting systems such as Internet e-commerce, mobile telephone networks and bank automatic teller machines and more. Encryption is also used in digital media copy protection, protecting against illegal copying of media, reverse engineering, unauthorized application analysis, and software piracy. Encryption can be used to ensure secrecy, but additional techniques are required to make communications secure. For example, communications can be secured by requiring verification of the integrity and authenticity of a message, e.g., by using message authentications codes (MAC) or digital signatures.

Wireless authentication and encryption allows the transmission of secure information over public, private and government wireless networks for executing a secure transaction, e.g., adding information to a system, acknowledging a systems or network event, or accessing a secure physical location such as a safe. One system and/or method for providing wireless authentication and encryption is based on an enhancement to Near Field Communications (NFC), as defined in ISO 14443. For example, this standard may be enhanced by requiring multiple authentication factors and utilizing various encryption methods, as described herein. Wireless authentication and encryption enables the use of wireless devices, including but not limited to a USB with a microCPU and wireless antenna, mobile communications devices such as mobile phones, smart phones, cell phones, smart Personal Digital Assistants, or any other portable wireless devices, for the purposes for the highly secure: transactions; information delivery; alert notifications; multi-media transmission; and value storage these portable devices as described herein. Stored value may be defined as but not limited to: encryption keys; user credentials; monetary units; official government documentation; payment transaction information; all forms of multi-media; personal documentation; legal documentation; and health information.

As used herein, the term intelligent token refers to flash, fob, dongle, token, and/or biometric devices including a microCPU configured to authenticate the identity of a user.

As used herein, the term secured intelligent token refers to an intelligent token further including software and/or hardware encryption built into the intelligent token for optimal security of the stored and/or communicated data. A secured intelligent token is one example of an authentication device, as used herein.

As used herein, protected information refers to data that is secured from access by unauthorized individuals or devices. For example, protected information may be password protected and/or encrypted.

As used herein, the term access key(s) refers to a secured communication mechanism to transmit a secured command to or between one or more devices to open or shut (e.g., lock or unlock, encrypt or decrypt, etc.) communications between the devices. For example, access keys may be, but are not limited to any one or more of the following, whether used independently or in any combination thereof: a key, a public key, a private key, a public and private key pair, a secret key, an encryption key, a high-grade key, a random key, a random generated key, a password, an encrypted value, a salt, a MAC, a digital signature, a credential, a certificate, an algorithm, a symmetric key algorithm, an asymmetric key algorithm, a cipher, block ciphers, stream ciphers, a code, a cryptographic hash, or any other similar data obfuscation procedure.

The present subject matter relates generally to a security, storage and communication system for preventing unauthorized access to physical or electronic assets. The secure system may be embodied in a user authentication device, which communicates with an associated secure device. The user authentication device includes a memory, an authentication factor input device, such as, but not limited to a biometric input device, bundled with stand alone applications and/or an independent operating system. In one embodiment, the secured device may be an associated PC configured to boot only after connecting the user authentication device based on the correct digital key association with a proprietary password, such as validating the fingerprint of the operator. In another application, the secured device may be a physical or electronic lock associated with the user authentication device, where in the lock will only open after the user authentication device validates the user's biometric information. Accordingly, the secure system may be implemented in just about any electronic device and may act as a firewall to prevent access to the operating system of the associated device. As further described herein, the user authentication device preserves the integrity of the user and the secured device preserves the integrity of the secured object or data. The secure system may be configured to accommodate any number of users, user authentication devices and secured devices and can be configured to operate as a one-to-one system, a one-to-many system, a many-to-one system or a many-to-many system.

Additional objects, advantages and novel features of the examples will be set forth in part in the description which follows, and in part will become apparent to those skilled in the art upon examination of the following description and the accompanying drawings or may be learned by production or operation of the examples. The objects and advantages of the concepts may be realized and attained by means of the methodologies, instrumentalities and combinations particularly pointed out in the appended claims.

### BRIEF DESCRIPTION OF DRAWINGS

The drawing figures depict one or more implementations in accord with the present concepts, by way of example only, not by way of limitations. In the figures, like reference numerals refer to the same or similar elements.

FIG. 1 is a schematic illustrating a system of the present invention utilizing a physical connection between a user authentication device and a secured device.

FIG. 2 is a schematic illustrating a system of the present invention utilizing a wireless connection between a user authentication device and a secured device.

### DETAILED DESCRIPTION OF PREFERRED EMBODIMENTS

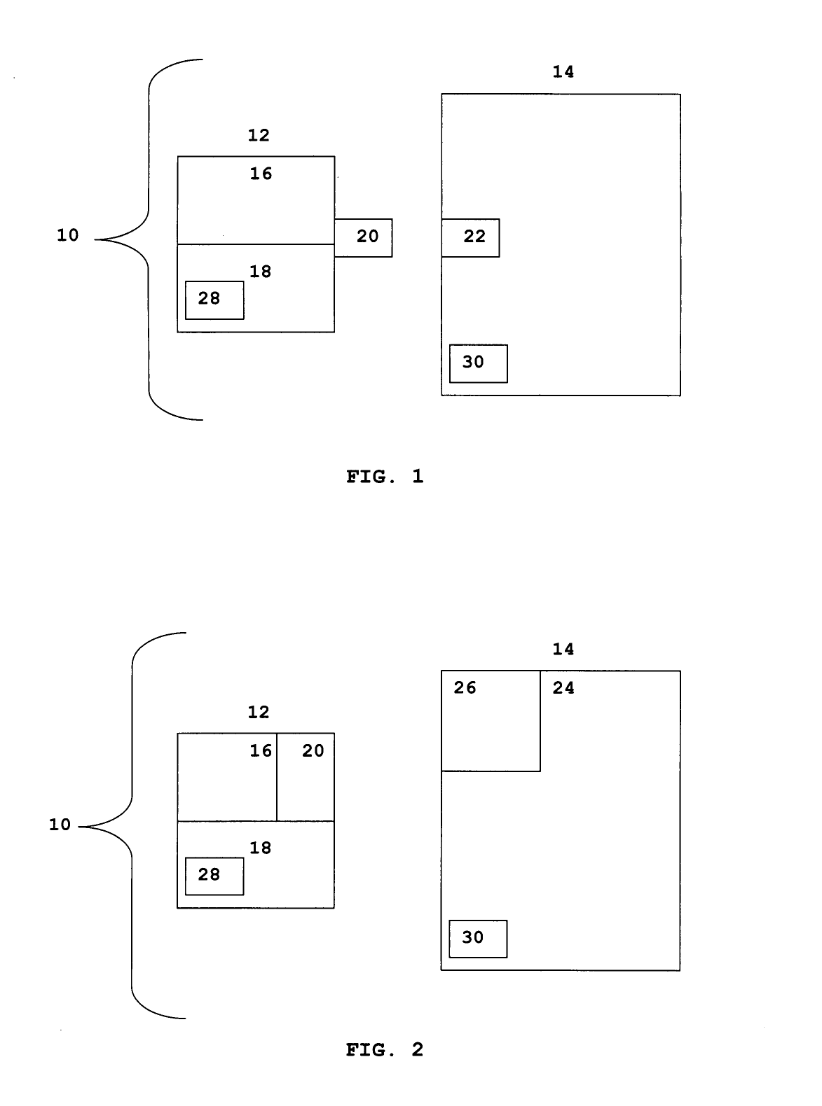

FIG. 1 illustrates a secure system 10 wherein a user authentication device 12 including a microCPU 28 cooperates with a secured device 14 having a microCPU 30 in order to secure access to the secured device 14. In the embodiment shown in FIG. 1, the secured device 14 will not operate until the user authentication device 12 authenticates a user, the secured device 14 authenticates the user authentication device 12 and any required access keys are communicated to the secured device 14. It is understood that the logic processing described herein with respect to the user authentication device 12 and the secured device 14 is carried out by their respective microCPU's 28 and 30 and the software and/or operating systems programmed thereto. Accordingly, the description of access keys being communicated to the secured device can be understood as access keys being communicated to the microCPU 30 of the secured device 14. It is further understood that the microCPU's 28 and 30 described herein may operate actively and/or passively to optimize operating conditions, including, for example, power management and battery life.

The communication pathway illustrated in FIG. 1, described further below, is a physical connection between the user authentication device 12 and the secured device 14. However, it is understood that any of the embodiments of the examples used herein may incorporate physical and/or wireless connections. Moreover, it is understood that the user authentication device 12 and the secured device 14 may communicate unilaterally and/or bilaterally.

FIG. 2 illustrates a secure system 10 wherein a user authentication device 12 cooperates with a secured device 14, such as, for example a lock 24, in order to secure access to a secured asset. In the embodiment shown in FIG. 2, the lock 24 will not open until the user authentication device 12 authenticates a user, the lock 24 authenticates the user authentication device 12 and any required access keys are communicated to the lock 24. The lock 24 and the assets secured by the lock may be physical, electronic or any combination thereof. The communication pathway illustrated in FIG. 2 is a wireless connection between the user authentication device 12 and the secured device 14. However, as described above, it is understood that any of the embodiments of the examples used herein may incorporate physical or wireless connections.

As shown in FIGS. 1 and 2, the user authentication device 12 includes a memory 16, bundled application software/firmware, an authentication factor input device 18, a communication port 20 and a microCPU 28 embedded within the user authentication device 12. The authentication factor input device 18 may be, for example, a user credentials input, an intelligent token and/or a biometric input. As shown in FIG. 1, the user authentication device 12 may be embodied in a dongle. Alternatively, the authentication device 12 may be embodied in any physical form, such as, for example, a token. The memory 16 may be any type of memory, including, but not limited to, the most minute micro memory capacity, flash, SD & CD flash technologies, hard disk drives and SIMMS. The authentication factor input device 18 may be, but is not limited to, for example, a biometric fingerprint scanner. It is contemplated that the authentication factor input device 18 may be any type of authentication factor input device 18. The microCPU 28 of the user authentication device 12 shown in FIG. 1 may include, but not be limited to, 64-256 bit hardware encryption. Alternatively, the microCPU 28 may use any type of encryption to secure and protect the information stored therein.

It is further contemplated that the authentication factor input device 18 used in the example illustrated in FIG. 1 is merely one form of input that may be utilized with the secure system 10. For example, any form of authentication information may be utilized in place of the biometric data, for example, a password, certificate, access code, etc. Similarly, the authentication factor input device 18 may be any type of input device, such as, for example, a keypad or touch screen.

The secured device 14 shown in FIG. 1 has a microCPU 30 and a communication port 22. In a PC logon routine, for example, the secure system 10 provided herein acts in front of the PC's BIOS and operating system and prevents any access thereto without proper authentication. It is understood that the secure system 10 may be implemented in just about any electronic device.

As illustrated in FIGS. 1 and 2, communication between the user authentication device 12 and the secured device 14 may be accomplished using any communication protocol, including, but not limited to, internet protocol (EP), radio frequency identification (RFID), Bluetooth, infrared (IR), magnetic swipe, smart card, wireless local area network (WLAN), voice over internet protocol (VoIP), Wi-Fi, Wi-Max, GSM/GPRS, GPS, CDMA, EvDO, TDMA (utilizing SIMM and USIMM platforms), short message service (SMS), multi media service (MMS) and general purpose interface (GPIO). The interface connectivity between the communication ports 20 and 22 may be provided by any interface, including, but not limited to, radio frequency (RF), IR, magnetic swipe, USB, Firewire, common access card (CAC) and serial or parallel interfaces. Encryption of the communication between the devices may be software or hardware based and may be employed at both the “master and/or slave” level.

In the examples shown in FIG. 1, the user authentication device 12 and secured device 14 communicate using a USB 2.0 interface. Accordingly, as shown in FIG. 1, the communication port 20 of the user authentication device 12 is a male ended USB connector and the communication port 22 of the secured device 14 is a female ended USB connector. The communication ports 20 and 22 may take various physical forms as required by the type of interface implemented.

A user enrolls its authentication factors in the user authentication device 12 by way of an enrollment process wherein the user authentication device 12 captures certain data and stores the data encrypted, or otherwise protected, in the memory 16 of the user authentication device 12. For example, the authentication device shown in FIG. 1 may enroll a user's biometrics. The enrollment process may be used to register the user as an authorized user to access the microCPU 28. Moreover, the enrollment process may be used to designate the administrative privileges granted to the user, for example, by designating the user as the primary user, owner, master or administrator of the secured device 14. In the enrollment process, commands are given to the microCPU 28 that is in shut-off mode until an authorized user is verified. In shut-off mode, there is no access to the microCPU 28. Depending on the user configuration of the microCPU 28, multiple users may be authorized via one or more enrollment processes.

In a PC boot up routine wherein the PC is the secured device 14, for example, once an initial enrollment process has been completed with the user authentication device 12, an authorized user may perform a pre-boot authentication routine to securely access the PC utilizing the secure system 10 shown in FIG. 1. The PC will not start until the proper access keys are received from the user authentication device 12 after proper authentication and validation with the microCPU 30 of the secured device 14. The pre-boot authentication routine ensures that the keys and commands given to the microCPU 30 are provided by an authorized user and prevents history traces of the protected access data from being stored in the secured device 14. Because the keys and authentication factors, for example a fingerprint template, are held in the user authentication device 12 separate from the microCPU 30 of the secured device 14 and are not accessible due to the encryption or other protection of the data, the user authentication device 12 functions as a firewall for access to the BIOS. The pre-boot authentication routine may include, for example, interfacing the user authentication device 12 with the microCPU 30 of the secured device 14 and scanning the user's fingerprint into the user authentication device 12. The pre-boot routine may further include other pre-boot authentication actions, including, for example, responding to additional security challenges, such as a series of encrypted challenges, user credentials or passwords presented by a secured encryption key posited in the microCPU 30, thereby creating another level of security.

When the user authentication device 12 receives authentication factor input from a user through the authentication factor input 18, the user authentication device 12 compares the incoming data to the authentication factor data stored in its memory 16. If the incoming authentication factor data matches stored authentication factor data for an authorized user, the user authentication device 12 transmits the access keys associated with the recognized user through the communication port 20 of the user authentication device 12 to the communication port 22 of the secured device 14. Upon receiving the appropriate access keys, the secured device 14 grants access to the user.

The secure system 10 shown in FIG. 1 can be used to connect computer peripherals and devices and allows for encryption and decryption of data, speech, optics and multimedia communications between different devices, for example, a USB mass storage device, a mobile phone, an IP phone, a camera, or another electronic device. The encryption and decryption between devices, utilizing multi-factor authentication, can be conducted without the need of a separate computer, but rather between two communicating microCPU's, for example microCPU 28 and microCPU 30. For example, a token functioning as a user authenticating device 12 may communicate with a cell phone functioning as a secured device 14. In another example, communicating cell phones can function as both user authentication devices 12 and secured devices 14 with respect to each other.

Similar to the example shown in FIG. 1, the secure system 10 can further be employed within a network, wherein access to the network or secured servers therein may be reserved for a limited number of individuals, for example, high-level executives.

As described above, FIG. 2 illustrates a secure system 10 wherein a user authentication device 12 cooperates with a microCPU 30 regulating the security of a lock 24 functioning as a secured device 14. The lock 24 will not open until the user authentication device 12 authenticates a user, communicated the correct access keys to the microCPU 30, the microCPU 30 of the lock 24 authenticates the user authentication device 12 and any required access keys are communicated to the lock 24.

The lock 24 shown in FIG. 2 includes a microCPU 30 and a communication port 26 for receiving a signal from the user authentication device 12. As shown in FIG. 2, the communication port 26 is an RF port. As further shown in FIG. 2, the lock 24 via its microCPU 30 may separately communicate with management control software, for example, in a company directory, for remote programming and monitoring of the lock 24. The additional layer of communication embodied in the microCPU 30, including another authentication factor, increases the redundancy factor for layer security.

The user authentication device 12 shown in FIG. 2 may be the same device shown in FIG. 1. However, in the embodiment shown in FIG. 2, the communication port 20 of the user authentication device 12 is an RF transmitter.

In one contemplated embodiment, the secure system 10 shown in FIG. 2 may be implemented in industrial areas where it is preferable to minimize physical contact between people and the environment. For example, the secure system 10 may be implemented in a hazardous chemical waste facility. In a hazardous chemical waste facility, the lock 24 may be contaminated by spores of hazardous material. With the remote communication between the user authentication device 12 and the lock 24, transmission of the hazardous material between the lock 24 and an authorized user can be minimized.

Further, in embodiments where hazardous waste contamination is not a danger, the secure system 10 shown in FIG. 2 can be supplemented by a separate input device, such as a wall mounted keypad, which may be used to initialize communication between the user authentication device 12 and the lock 24 or to provide additional challenge responses between microCPU 28 and microCPU 30.

The following non-limiting examples are provided to further demonstrate secured systems 10 according to the present invention.

In an example a USB based secured intelligent token functions as the user authentication device 12 associated with a PC functioning as a secured device 14. The user authentication device 12 includes a male ended USB communication port 20 for mating with a female ended USB communication port 22 in the secured device 14. After obtaining and verifying authentication factors input from the user through the authentication factor input 18, the user authentication device 12 will initiate a secure data exchange with the secured device 14. Access to the secured device 14 will only be granted after the user authentication device 12 has authenticated a user through its microCPU 28, identified itself to the secured device 14 and been authenticated by the microCPU 30 in the secured device 14.

In this example, the first step in the communications between the user authentication device 12 and the secured device 14 is a verification initialization. When the USB port 20 of the user authentication device 12 is inserted into the USB port 22 of the secured device 14, the user authentication device 12 receives power through pins 1 and 4 of the USB ports 20 and 22. From the perspective of the USB interface 20 and 22, the secured device 14 is a USB host. It is understood that any number of electronic devices may satisfy the specifications of a USB host. This initiation of power causes the microCPU 28 of the user authentication device 12 to jump to its power up vector and begin executing its on-board programming. The user authentication device 12 will obtain authentication from a user through the authentication factor input device 18. After proper authentication factors have been obtained, the microCPU 28 of the user authentication device 12 will initiate an attempt to authenticate to the microCPU 30 of the secured device 14.

The authentication process between the user authentication device 12 and the secured device 14 involves an exchange of messages between the user authentication device 12 and the secured device 14. Each message in this exchange is encrypted with the Advanced Encryption Standard (AES), using a 256-bit encryption key. This level of encryption has been approved by the National Security Agency for all levels of unclassified and classified information, including Top Secret information.

The implementation used for this encryption, uses a password whose length is between 48 and 63 characters. Identical password values must be pre-configured in the user authentication device 12 and secured device 14 prior to the authentication process. The password, along with a randomly generated 16-byte value, called the salt, is used to generate a 32-byte (256-bit) AES key. The algorithms used to generate the salt and the key, are defined by RFC 2898.

In addition to AES encryption, each message is digitally signed with a 10-byte Message Authentication Code (MAC). The MAC is used to verify that the encrypted message received is indeed the message that was sent. That is, it validates that the content of the message has not been altered. Further more, it validates that the message was encrypted with the specific password. That is, upon receipt, the MAC value will not validate if either the message had been altered, or if a different password was used to encrypt the message.

When a message is sent, from either the user authentication device 12 or the secured device 14, the following is an example of steps that may occur:

1. In the originator of the message (the sender)
a. A random salt value is generated.
b. The pre-configured password and the salt are used to generate a 256-bit length key.
c. The message is encrypted with AES, using the 256-bit length key.
d. Using the secret password and the message, a 10-byte MAC value is generated.
e. The salt value, the encrypted message and MAC value are sent to the destination.

2. In the destination (the receiver)
a. The received salt value and the pre-configured password are used to generate a 256-bit length key.
b. This key is used to decrypt the message.
c. The password and message are used to generate a MAC value.
d. This generated MAC value is compared to the received MAC value. If they are identical, the received message is valid. Otherwise the received message is deemed invalid.

Though the above section is based on AES, the Challenge Response Protocol is not limited to AES. Many other encryption algorithms can be used. One such algorithm is Blowfish. Unlike AES, Blowfish starts with a key value (instead of a password), ranging from 32 to 448 bits in length. For more secure encryption, higher key lengths (128 and above) is recommended.

The Blowfish algorithm does not specify the use of a MAC, however MAC generation can easily be combined and used with Blowfish.

The Challenge Response message set consists of four messages. The exchange is initiated from the user authentication device 12, which sends a Verification Request message to the secured device 14. Since the user authentication device 12, at this point, does not know that it is communicating with a trusted secured device 14, minimal information is sent with this message.

The secured device 14 receives this message, decrypts it and validates the MAC. If the message does not validate, or the decrypted message does not match the Verification Request command, then no response will be sent from the secured device 14 to the user authentication device 12. This lack of response is preferred over a negative response, as it provides no feedback to the suspect user authentication device 12.

It is possible that the user authentication device 12 is valid and that messages between the user authentication device 12 and secured device 14 have gotten out of sync, such that the secured device 14 is receiving this message out of context. To correct this problem, the person attempting authentication can remove and reinsert the user authentication device 12 from the USB port on the secured device 14, and begin the authentication process again. This action will synchronize the two devices.

If the MAC sent with the message is validated, and the message is recognized as a Verification Request, the secured device 14 will respond with a Verification Pending message. Again, this message is encrypted and sent with a MAC. At this point the secured device 14 can view the user authentication device 12 as a trusted device, since it sent a message with a valid password. However, the person using the user authentication device 12 may not yet be trusted.

The user authentication device 12 receives the Verification Pending message, decrypts it and verifies the MAC. As before, if the MAC does not verify or the message content is not recognized as the Verification Pending command, then the user authentication device 12 does not respond to the secured device 14, and communication with the secured device 14 is terminated.

If the Verification Pending message is verified, then the user authentication device 12 to the secured device 14 with the Verification Information message. This message may contain the identification information of the person being verified (e.g. name, contact information, etc.). As always, this message is encrypted and sent with a MAC for validation.

After the secured device 14 decrypts and validates this message, the identity information may be used to verify that the person is indeed an authorized user of the secured device 14. In addition, the information can also be used to create an entry in a usage log in the secured device 14. If the person is not an authorized user, no response is sent back to the user authentication device 12. If the person is an authorized user, the secured device 14 will respond with the Verification Accepted message.

After the secured device 14 decrypts and validates this message, the identity information may be used to verify that the person is indeed an authorized user of the secured device 14. In addition, the information can also be used to create an entry in a usage log in the secured device 14. If the person is not an authorized user, no response is sent back to the user authentication device 12. If the person is an authorized user, the secured device 14 will respond with the Verification Accepted message.

As the messages are constructed in the user authentication device 12 (the Verification Request and Verification Information messages), before encryption, the bytes of the messages are summed. Prior to sending the Verification Information message, a byte whose value is the two's complement of the current sum, is added to that message. As a result, the sum of all bytes in these two messages will be zero.

When the secured device 14 receives the Verification Information message, it verifies that the sum of the bytes across both received messages is zero. If it is not, the authentication is not valid.

During the message exchange, when a message is not valid, no response message is sent. As a result the device could be left waiting infinitely. By contrast, each device should time out while waiting, if the expected response has not been received. A reasonable timeout of 1 or 2 seconds may be used.

While waiting for the Verification Pending or Verification Accepted messages, the user authentication device 12 could timeout. In that case, the user authentication device 12 should terminate communications with the secured device 14. It should not send messages to the secured device 14, nor accept messages received from the secured device 14.

The secured device 14 might also timeout, while waiting for the Verification Information message from the user authentication device 12. Upon such a timeout, the secured device 14 should terminate communications with the user authentication device 12.

Physically removing the user authentication device 12 from the USB port and re-inserting will reset the communications between the devices.

Both devices should provide no feedback to the person attempting to be authenticated, to indicate that the authentication failed, since such feedback conveys information that would benefit an illegitimate person.

When a technical design requires that there be a secured communication dialogue between two separate objects or devices, then a secured and bilateral communication is made between said objects utilizing an asymmetric challenge response. A challenge response dialogue is created to compare and validate stored and encrypted information, including the encryption keys, values, stored message, voice data, and including but not limited to streaming video.

For example:

The user authentication device 12 is a fingerprint verification unit.

The secured device 14 is a hard disk.

The user authentication device 12 and the secured device 14 hold the same encryption algorithm and the same secret key, for example, key size 32 bytes. (ATA command uses 32 bytes.)

1) The user authentication device 12 sends a notification to the secured device 14 that it wants to perform an authentication (in order to “open” the secured device 14). This may be called a “wake up.”

2) The secured device 14 sends a “challenge string” to the user authentication device 12 (this is the challenge).

3) While sending the challenge, the secured device 14 uses encryption with the secret key to calculate the expected reply from the user authentication device 12. There is no need to save the challenge string by either the user authentication device 12 or the secured device 14. The sending unit can perform encryption for each byte transmitted and the receiving unit can perform encryption byte for byte as they are received.

4) The user authentication device 12 receives the challenge and uses encryption with the same secret key to calculate the reply.

5) The user authentication device 12 sends the reply to the secured device 14.

6) The secured device 14 checks the reply. If the reply has the expected value unit B will send a message to the user authentication device 12 confirming a successful authentication and “opens” it resources.

7) The user authentication device 12 can now access resources in the secured device 14.

The secured device 14 should have a Random Generator that will produce a truly random “challenge string” (it must create random numbers each time it is initiated). The challenge string should be at least 128 bytes. The first “challenge string” after power up must be unique at each power up. In no case should it repeat the same “challenge string” or make them in a predictable sequence. Other restrictions may be out on the “challenge string” in order to make it harder to calculate the secret key.

Further, the size of the reply should be 16 bytes with the start value all zero. When the challenge string is encrypted byte for byte, the resulting byte values are added to the reply in the following way: reply[0], reply[1], reply[2], reply[3], reply[4], reply[5], reply[6], reply[7], reply[0], reply[1], reply[2] . . . , This makes it impossible to calculate the hidden key from the openly transmitted reply. Each of these 16 bytes will have a sum of 8 encrypted bytes individually. There will be an overflow in each of these bytes, but this doesn't matter as the receiving unit will have the same overflow, and the value will be exactly the same.

There is of course need for some kind of very simple primary protocol like STX and a code (some command) for “wake up”, “reply” and “authentication OK”, but there is really no need for CRC (a check sum, which is evaluated once the message is received) because the 16 bytes mentioned above have been canceled out to zero calculations as a correct reply is enough. If there is a CRC available, then it can be used anyway.

Another embodiment of FIG. 1 may provide for the secured login of an authorized user to a PC to access a secured hard disk drive (SHDD) at pre-boot. This would entail the user be the qualified and authenticated owner/user of a user authentication device 12 whereby said user initiates a communication dialogue with the SHDD. Users of such a user authentication device 12 could be a high government official with state secrets stored on the SHDD in his/her laptop. Even though that information may be secured with software and hardware encryption, added security would be the adoption of a user authentication device 12 that could be transferred to the destination of that diplomat's trip, to then be used as the third factor authenticating key to access said laptop's SHDD. A human factor dynamic is undertaken in this example because the user authentication device 12 was transported at a different time and place than the laptop, to then be employed when accessing the stored and encrypted data. User policy is and will always be the extra level of security that may make the difference for degrees of security.

In its most remedial sense, a user authentication device 12 allows for stationary and remote communication via an encrypted dialogue whereby the SHDD or HDD may be securely accessed, an enterprise server may be securely accessed, or any software encrypted folder/file residing in the SHDD or a secured sever can be securely accessed, remote access is enabled through authentication and verification via a USB port of another PC that is IP/LAN or WAN, or wirelessly connected to the secured device 14 housing the SHDD/HDD or to a secured server. Encrypted communication may be employed for internet port access.

As described above, the secure system 10 shown in FIG. 1 can be used to connect computer peripherals and devices and allows for encryption and decryption of data, speech, optics and multimedia communications between different devices, for example, a USB mass storage device, a mobile phone, an IP phone, a camera, or another electronic device. The encryption and decryption between devices, utilizing multi-factor authentication, can be conducted without the need of a separate computer, but rather between two communicating microCPU's, like microCPU 28 and microCPU 30. Accordingly, another embodiment of the secure system 10 could be an investment banker using a user authentication device 12 to connect to a secured device 14 via USB ports 20 and 22 in order to execute encrypted communication through a secured communication protocol.

In another embodiment of the secure system 10 a user purchases an item at a mall, grocery store, gas station, or any physical store offering a good or service. The user utilizes his or her user authentication device 12, a mobile device bundled with secured software/firmware containing multi-factor authentication and point-to-point encrypted communications, for the purpose of paying for the good or service. This is completed by running a payments application on the endpoint device paired against wireless communications, authentication and encryption software, firmware or hardware on the point of sale device, the secured device 14. Authentication occurs via the authentication process in the security and communications technology secured software/firmware, and the transaction is recorded in the payments application. The payments application may utilized several forms of wireless communications, including, but not limited to, infrared, RFID, WiFi, or other like wireless communications.

Another embodiment of the secure system 10 utilizes a mobile communications device for the purposes of predefined and prescreen access through security checkpoints such as an airline terminal, highly secured buildings, chemical facilities, and more. By pre-authenticating a person and providing the person's credentials as stored value on their mobile communicator bundled with the secured software/firmware, the user authentication device 12, the person, once authenticated on the mobile communicator, may initiate an encrypted wireless communications process as a security checkpoint, the secured device 14, verifying and positively identifying them for enhanced a speedy clearance through the security checkpoint.

Another embodiment provides for the authenticated and encrypted storage of personal medical records, documents, films, scans of all multi-media formats, on a personal communications device, a user authentication device 12. In this case, one can assume a mobile phone, yet this is not limited to a mobile phone. The mobile phone maintains a private, hidden area of memory bundled with the secure software/firmware for the express purposes of storing personal health records. Once authenticated, the phone can serve as the default storage device of an individual, allowing them a complete copy of their personal records in a secure, portable storage device. If lost, only through positive multi-factor authentication to the device and then again to the individual health records could the information be access. Given the wireless capabilities of the mobile phone, it can be utilized for upload and download of this information from a series of physician offices, medial labs and hospital facilities, each a secured device 14, providing for a single secure location of all health records, including, for example, prescription drug records. Also, given the wireless capabilities, payment capabilities of storing value such as cash, credit cards, bank records, etc., on the devices in a secure and authenticated fashion, the mobile phone can be utilized for purposes of payments, scheduling, and inter-physician communication.

Another embodiment could be a financial executive, healthcare physician, insurance executive, or a government official using a USB based user authentication device 12 to connect to a PC, a secured device 14, via USB ports 20 and 22 in order to execute encrypted communication through a secured communication protocol. As an example, an investment banker may want to talk and send data to a very high profile client that demands absolute privacy. This may be undertaken by encrypting the data that resides in the user authentication device 12 or data that resides on the secured device 14. Then creating an encryption key associated with that encrypted data to be sent via an encryption communication pathway or tunnel by way of a chat box embedded in a secured softphone that resides and is executed from the user authentication device 12 itself. The investment banker not only sends encrypted data packets, but does so in encrypted communication as he/she is speaking to the client in an encrypted communication tunnel. If they want to see each other, then the same user authentication device 12 may be used to create a an encryption key that will be used to access a secured virtual safe room, where a secured video session may be initiated by those who have the right encryption key to enter it. Because the user has encrypted data and voice, he/she may also encrypt video streams for secured video conference. In this example, both user's devices function as user authentication devices 12 with respect to the user and the safe room would be the secured devices 14.

It is understood that the bilateral communication between devices can result in each user possessing a device that functions as both a user authentication device 12 and a secured device 14. For example, if secured and authenticated communications between cell phones is desired, a first user may have a cell phone that functions as a user authentication device 12 with respect to the first user and functions as a secured device 14 with respect to the second user's cell phone. Similarly, the second user may have a cell phone that functions as a user authentication device 12 with respect to the second user and a secured device 14 with respect to the first user's cell phone.

By using an a user authentication device 12, for example, an authenticated user may employ robust and multi-tasking objectives by utilizing the user authentication device 12 with a central management console, whereby user credentials may be created and loaded into the user authentication device(s) 12. This may be done by a secured communication dialogue between the user authentication device 12 and the central management console residing on a server. As such, updating, deleting, editing, and user profile and security threshold management may be conducted remotely and most likely monitored at a supervisory level. As an example, in the hospitality, entertainment, and gaming, industries the utilization of user authentication device 12 may be employed for security, user policy, tracking and monitoring, as well as validating the credit worthiness of an individual.

An example of this is that in most hotels/spas, an individual can charge meals or other services to their respective hotel room. These invoices can easily be billed to a fictitious name and room number at any time. An individual can walk into a hotel and order a meal. The invoice is delivered and the individual can pay cash, use a charge card or charge the amount to a hotel room number. If the individual elects to charge the meal to a room, the individual can identify any room and even fake the name due to the fact that this information is not tracked quickly or to an accurate guest name. The individual can therefore, sign or scribble a name on the invoice and leave the hotel thereby, never actually paying for the food or service. There is no way to confirm the accurate guest is being invoice properly. When an individual checks in to a hotel/spa, he/she normally receives a door key (plastic card) along with potentially a mini-bar key. The hotel/spa is already in the process of confirming the individuals/new guest's identification. In most cases, a credit card is also swiped for confirmation and potential future charges. By utilizing a user authentication device 12, for example, an encrypted flash drive or dongle, when the guest is checking into the hotel/spa, the authentication of the guest is already in process and information is password protected. Fingerprint and other biometric technology could also be a form of authentication. The guest can use the user authentication device 12, password protected, throughout the hotel, valet, spa or theme park. All charges are authentic and only to the guest who has been verified. The hotel/spa or theme park could have kiosks so the guest can review the billing or invoices that are being charged to him/her during their stay. The kiosks would also eliminate time during check out. Many hotels/spa's have television check out processes to confirm billing, closing out the invoice or identify potential billing errors. The hotel could also use the keyboard already in most hotels for games and the like, as the process for checkout with the user authentication device 12 with passwords. All these methods would be using encrypted authentication. As an example, prior to any meal or service, the individual guest would produce the user authentication device 12 to confirm authentic identification. If the individual prefers to pay cash, the payment would be submitted and information transferred to the user authentication device 12. If someone does not have a user authentication device 12, then the restaurant is now alerted that this individual may not be a registered guest and credit card or cash payment would be expected. The user authentication device 12 would be the billing process for the guest. It also requires authentication so prior to being charge, a password could be utilized to confirm the charges. Each billing station in the hotel/spa or theme park would have a process where the user authentication device 12 would be updated as the guest stays. The guest has to produce the user authentication device 12 throughout the hotel/spa or theme park as you would a key card for entrance to a hotel room. When checking out, the user authentication device 12 would be returned. Due to authentication, if this user authentication device 12 is lost or taken home in error, only the individual can authenticate the user authentication device 12, and the credit card initially submitted would be charged accordingly.

It should be noted that various changes and modifications to the presently preferred embodiments described herein will be apparent to those skilled in the art. Such changes and modifications may be made without departing from the spirit and scope of the present invention and without diminishing its attendant advantages.

We claim:

1. A secure system comprising:
a user authentication device including memory for storing information, one or more authentication factors, access key information, a microCPU, an authentication factor input and a communication port; and
a secured device including a microCPU and a communication port that receives access key information from said authentication device, wherein a user is granted access to said secured device after the user is authenticated by said user authentication device and said user authentication device is authenticated by said secured device.

2. The secure system of claim 1 wherein said communication ports communicate through a physical or wired connection.

3. The secure system of claim 1 wherein said communication ports communicate through a wireless connection.

4. The secure system of claim 1 wherein said user authentication device is a stand alone battery powered device.

5. The secure system of claim 1 wherein said user authentication device is powered by said secured device or vice versa.

6. The secure system of claim 1 wherein said secured device is powered by said user authentication device.

7. The secure system of claim 1 wherein said user authentication device communicates unilaterally with said secured device.

8. The secure system of clam 1 wherein said user authentication device and said secured device communicate bilaterally.

9. The secure system of claim 1 wherein the communications between said user authentication device and said secured device are encrypted.

10. The secure system of claim 1 wherein said information stored in said memory of said user authentication device is encrypted.

11. The secure system of claim 1 wherein said user authentication device functions as a secured device with respect to another user authentication device.

12. The secure system of claim 1 wherein said secured device functions as a user authentication device with respect to another secured device.

13. The secure system of claim 1 wherein a plurality of user authentication devices is associated with said secured device.

14. The secure system of claim 1 wherein a plurality of secured devices is associated with said user authentication device.

15. The secure system of claim 1 wherein multiple users' authentication factors are stored within said user authentication device.

16. The secure system of claim 1 wherein multiple users' authentication factors are stored within said secured device.

17. A method of providing secured access to a device comprising the steps of:
providing a user authentication device including memory, a microCPU, access key information, an authentication factor input and a communication port;
providing a secured device including a microCPU and a communication port;
enrolling a user's identification data in the user authentication device, including the steps of storing the user's authentication factors and associating the user's authentication factors to one or more access keys, wherein the authentication factors and one or more access keys are stored in or generated by the user authentication device;
authenticating the user's to the user authentication device by receiving authentication factor input through the user authentication device and comparing the identification data input to the stored identification data; and
if the authentication factor input through the authentication device matches the identification data stored in the user authentication device, authenticating the user authentication device to the secured device by communicating the one or more access keys associated with the user through the user authentication device's communication port to the secured device's communication port, thereby granting the user access to the secured device.

18. The method of claim 17 further including the step of enabling the user authentication device to generate random keys after the user has been authenticated.

19. The method of claim 17 further including the step of providing a challenge response protocol between the user authentication device and the secured device to further secure access to the secured device.

20. A method of providing secured access to a device comprising the steps of:
providing a user authentication device including, a microCPU, an authentication factor input and a communication port;
providing a secured device including a microCPU, memory, access key information and a communication port;
enrolling a user's identification data in the user authentication device, including the steps of storing the user's authentication factors and associating the user's authentication factors to one or more access keys, wherein the authentication factors and one or more access keys are stored in or generated by the secured device;
authenticating the user's to the user authentication device by receiving authentication factor input through the authentication device and comparing the identification data input to the stored identification data; and
if the authentication factor input through the authentication device matches the identification data stored in the secured device, authenticating the user authentication device to the secured device by communicating the one or more access keys associated with the user through the secured device's communication port to the authentication device's communication port, thereby granting the user access to the secured device.
